(19) United States
(12) Patent Application Publication
(10) Pub. No.: US 2016/0171378 A1
(43) Pub. Date: Jun. 16, 2016

(54) TIME OUT-OF-HOME MONITORING

(71) Applicant: OREGON HEALTH & SCIENCE UNIVERSITY, PORTLAND, OR (US)

(72) Inventors: Johanna Petersen, Portland, OR (US); Daniel Austin, Portland, OR (US); Jeffrey Kaye, Portland, OR (US); Misha Pavel, Portland, OR (US); Tamara Hayes, Portland, OR (US)

(73) Assignee: OREGON HEALTH & SCIENCE UNIVERSITY, PORTLAND, OR (US)

(21) Appl. No.: 14/969,122

(22) Filed: Dec. 15, 2015

Related U.S. Application Data
(60) Provisional application No. 62/092,032, filed on Dec. 15, 2014.

(51) Int. Cl. G06N 5/04; G06N 99/00; G06N 7/00; G06F 17/30

(52) U.S. Cl. CPC G06N 5/04; G06F 17/30598; G06N 99/005; G06N 7/005

(57) ABSTRACT

Systems and methods for determining time a subject spends outside of their home based on signals received from unobtrusive sensors in the home are disclosed. In one example approach, a method for determining time a subject spends outside of their home comprises receiving sensor firing data for a duration from sensors in the home, dividing the duration into epochs, extracting features from the sensor firing data received during the epoch, and classifying each epoch as out-of-home or in-home based on the features extracted from the sensor firing data during the epoch.

### ACKNOWLEDGMENT OF GOVERNMENT SUPPORT

This invention was made with United States government support under the terms of grant numbers R01AG024059, P30AG024978, and P30AG008017 awarded by the National Institutes of Health. The United States government has certain rights in this invention.

### FIELD

The present disclosure relates to the field of in-home health monitoring, and, more specifically, to systems and methods for determining time a subject spends outside of their home.

### BACKGROUND

Loneliness, or perceived social isolation, is a common condition that is particularly prevalent in elderly where retirement, the death of friends, and the subtle decline in health pose challenges to forming and maintaining friendships. In some studies, nearly 20% of seniors self-reported as occasionally lonely (Theeke L A, Arch Psychiatr Nurs 23, 387-396 (2009); incorporated by reference herein), while 5-15% of elders reported frequent loneliness (Pinquart M and Sorensen S, Basic and Appl Soc Psych 23, 245-266 (2001); incorporated by reference herein). In such populations, loneliness is particularly problematic since it predicts morbidity and mortality (Luo Y et al, Soc Sci Med 74, 907-914 (2012); Perissinotto C M et al, Arch Intern Med 172, 1078-1083 (2012); and Tilvis R S et al, J Aging Res 2011, 534781 (2011); all of which are incorporated by reference herein), causes decreased cognitive functioning (Wilson R S et al, Arch Gen Psychiatry 64, 234-240 (2007); incorporated by reference herein), impairs sleep quality leading to daytime dysfunction (Cacioppo J T et al, Psychol Sci 13, 384-387 (2002) and Hawkley L C et al, Health Psychol 29, 124-129 (2010); both of which are incorporated by reference herien, decreases mobility which increases risk of falls (Buchman A S et al, BMC Geriatr 10, 77 (2010) and Faulkner K A et al, J Gerontol A Biol Sci Med Sci 58, M954-959 (2003); both of which are incorporated by reference herein), and reduces quality of life. For these reasons, detection and mitigation of loneliness is critical, as the deleterious effects of loneliness can be reversed with an appropriate intervention (Hawkley L C and Cacioppo J T, Ann Behav Med 40, 218-227 (2010); incorporated by reference herein). However, physicians currently do not assess loneliness in the clinical setting and many of the aforementioned correlates of loneliness can cause lonely people to go unnoticed by people and programs attempting to reach out to them, making detection of lonely individuals difficult.

Smart homes, which comprise homes, residences, or spaces outfitted with various sensors and/or cameras, have the ability to continuously and unobtrusively monitor inhabitants (Hayes T L et al, in Technology and Aging Assistive Technology Research Series Mihailidis A et al Eds IOS Press 2008 (130-137); Demiris G and Hensel B K Yearb Med Inform 33-40 (2008); and Skubic M et al, Technol Health Care 17, 183-201 (2009); all of which are incorporated by reference herein). The inventors herein have recognized that such smart home platforms may be used to monitor and detect loneliness at its earliest phases. In some approaches, wearable devices may be used to monitor activities of a resident. While multiple approaches to smart home and wearable technology exist (Joshua R S et al, Commun ACM 48, 39-44 (2005); incorporated by reference herein), memory problems and privacy concerns in the elderly hamper the efficacy of devices worn on the body and cameras in the home. Some approaches estimate time out of home simply by analyzing times when no in-home activity (e.g., as measured by x10 motion sensors) is detected before or after a firing of a door sensor, for example. However, in such approaches, the noisiness of the door sensors and motion sensors leads to inaccuracies in detecting outings from the home.

### SUMMARY

The present disclosure is directed to systems and methods for determining time a subject spends outside of their home, referred to herein as time out-of-home, based on signals received from unobtrusive sensors in the home, e.g., door sensors and motion sensors. In one example approach, a method for determining time a subject spends outside of their home comprises receiving sensor firing data for a duration from sensors in the home, dividing the duration into epochs, extracting features from the sensor firing data received during the epoch, and classifying each epoch as out-of-home or in-home based on the features extracted from the sensor firing data during the epoch. Embodiments described herein overcome many of the above-described challenges associated with noisy door and motion sensors to accurately estimate time out-of-home, e.g., in older adults, and provides an increased sensitivity and specificity to time out-of-home estimations. While previous approaches, examples of which are described above, relied heavily on the door sensors, the approaches described herein accommodate noisiness in the door and motion sensors by overcoming it probabilistically thereby improving estimation accuracy of time out-of-home.

Embodiments described herein use the various features extracted from unobtrusive and/or passive sensor data to estimate, for each epoch (e.g., each five minute interval), whether someone was in the home or not. In some embodiments, features extracted from the sensor data may include features that correspond to the opening and closing of an exterior door to the home thereby making it possible for either the door opening event to fire appropriately or the door closing event to fire appropriately to mark a period as an out of home event, rather than relying on both to happen. Additionally, in some examples, features extracted from the sensor data may include a feature corresponding to the room the subject is in when the last sensor fired, thereby providing more information to the time out-of-home estimation algorithm, and making it difficult to mark the subject as out of home if the last sensor fired in the bedroom, for example, as it's difficult to get from the bedroom to the door without tripping other sensors in between.

Embodiments disclosed herein may be used for objectively, unobtrusively, and accurately detecting time spent out-of-home, a critical component of loneliness. This is in large part because loneliness often presents with a decline in physical activity (Hawkley L C et al, Health Psychol 28, 354-363 (2009); incorporated by reference herein, decreased motor function (Buchman 2010 supra), and increased risk of depression (Aylaz R et al, Arch Gerontol Geriatr 55, 548-554 (2012); incorporated by reference herein), all of which are associated with more time spent in the home. Loneliness is also associated with sleep disruptions and daytime dysfunction (Cacioppo 2002 supra). Daytime dysfunction may not only increase time spent inside the home, but also reduce activity while in the home. For this reason, accurately detecting when an individual leaves the home as described herein may be used to assess daytime dysfunction.

Additionally, embodiments disclosed herein may be used in other applications to monitor and detect various states, e.g., health states, of a subject. For example, fewer outings has been linked to decreased cognitive functioning, suggesting its importance for detecting cognitive decline (Suzuki T and Murase S et al, Telemed J E Health 1, 686-690 (2010); incorporated by reference herein). More generally, measuring time spent out-of-home across a large number of individuals may permit investigation into general behavioral patterns such as how elderly spend their time during the day, what the regularity of these patterns is over the course of the day, and what sort of changes exist between weekday and weekend out-of-home profiles. Embodiments described herein may be used to generate out-of-home profiles for identification of such behavioral patterns and identification of variable out-of-home profiles that may be used to mitigate risks. For example, larger variability in out-of-home profiles may allow detection of individuals at higher risk of loneliness.

This Summary is provided to introduce a selection of concepts in a simplified form that are further described below in the Detailed Description. This Summary is not intended to identify key features or essential features of the disclosed subject matter, nor is it intended to be used to limit the scope of the disclosed subject matter. Furthermore, the disclosed subject matter is not limited to implementations that address any or all disadvantages noted in any part of this disclosure.

### BRIEF DESCRIPTION OF THE SEVERAL VIEWS OF THE DRAWINGS

FIG. 1 shows a schematic diagram of an example system for monitoring time a subject spends outside of their home in accordance with the disclosure.

FIG. 2 shows an example receiver operating characteristic (ROC) curve of a disclosed time out-of-home estimation model performance.

FIG. 3 shows an example graph of estimated daily time out-of-home as a function of actual daily time out-of-home.

FIG. 4 shows an example graph of loneliness score as a function of average time spent outside the home over five days up to and including a survey administration.

FIG. 5 shows an example graph of mean and 95% confidence interval (CI) of the probability of being out of the home as a function of the time of day for 51 elderly subjects over the course of 30 days.

FIG. 6 shows example graphs of average probability of being out of the home as a function of the time of day for five different individuals over 30 days with varying loneliness scores.

FIG. 7 shows a graph of physical activity score as a function of average time spent outside the home over the four days up to and including survey administration (top panel) and a graph of Pearson's correlation coefficient (r) between average time outside home and physical activity score (bottom panel).

FIG. 8 schematically shows an example computing system in accordance with the disclosure.

### DETAILED DESCRIPTION

The following detailed description is directed to systems and methods for determining time a subject spends outside of their home, referred to herein as time out-of-home, based on signals received from unobtrusive sensors in the home, e.g., door sensors and motion sensors. In the following detailed description, reference is made to the accompanying drawings that form a part hereof, and in which are shown by way of illustration embodiments that may be practiced. It is to be understood that other embodiments may be utilized and structural or logical changes may be made without departing from the scope of this disclosure. Therefore, the following detailed description is not to be taken in a limiting sense. Various operations may be described as multiple discrete operations in turn, in a manner that may be helpful in understanding embodiments; however, the order of description should not be construed to imply that these operations are order dependent and, in some examples, one or more operations described herein may be omitted.

As remarked above, loneliness is a common condition associated with severe health consequences including increased mortality, decreased cognitive function, and poor quality of life. Identifying and assisting lonely individuals is therefore increasingly important, especially in the home setting, as the very nature of loneliness often makes it difficult to detect by traditional methods. One critical component in assessing loneliness unobtrusively is to measure time spent out-of-home, as loneliness often presents with decreased physical activity, decreased motor functioning, and a decline in activities of daily living, all of which may cause decreases in the amount of time spent outside the home. Accordingly embodiments disclosed herein extract features from data obtained from passive and unobtrusive in-home sensing technologies to estimate time spent out-of-home based on a classification model.

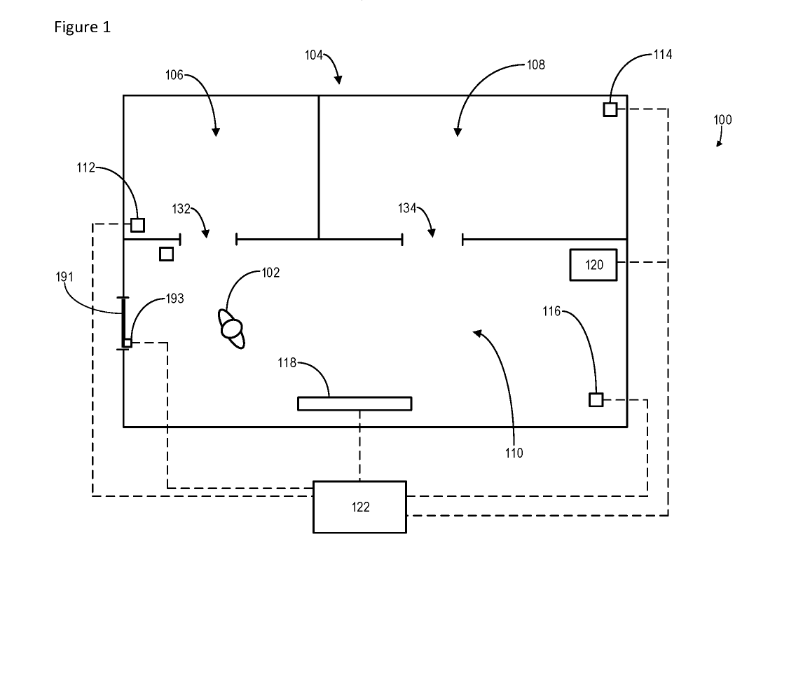

FIG. 1 shows a schematic diagram of an example system 100 for monitoring time a subject 102 spends outside of their home 104. Home 104 may include a plurality of rooms, e.g., room 106, room, 108, and room 110. As used herein, the term “home” is used to refer to any suitable physical space or dwelling such as a house, an apartment, a floor of a house, an area of an office building, an area in a shopping mall, an outside area, etc. As used herein, the term “room” is used to refer to any delineated area in a home, e.g., a room in an apartment, house, or office building, or a delineated region or location in an outside space, a shopping mall, etc. By way of example, FIG. 1 shows three rooms 106, 108, and 110. For example, room 106 may be a bathroom, room 108 may be a bedroom, and room 110 may be a living room. Home 104 includes at least one exterior door from which subject 102 may exit or leave home 104. For example, FIG. 1 shows an exterior door 191 which provides an exit from the home from room 110. Door sensors may be in communication with or coupled to the exterior doors of the home. For example, door sensor 193 is in communication with exterior door 110 in FIG. 1. In some examples, the door sensors may comprise contact sensors, e.g., magnetic contact sensors, which are configured to emit a first signal when the contact sensor is in a first position and a second signal, different from the first signal, when the contact sensor is in a second position. One or more rooms of home 104 may be such that subject 102 can directly exit the home via an exterior door from the room, without having to pass through any other room or space of the home. For example, in FIG. 1, the subject could directly leave the home from room 110 via door 191.

Each room in the plurality of rooms in the space may include at least one motion sensor or motion detector. For example, in FIG. 1, motion sensor 112 is positioned in room 106, motion sensor 114 is positioned in room 108, and motion sensor 116 is positioned in room 110. Each motion sensor in each room may comprise any suitable motion sensor or motion detector utilizing any technology and may be positioned at any suitable location in a room. For example, each motion sensor may comprise an electronic motion detector which contains an optical, microwave, and/or acoustic sensor and, in some examples, a transmitter for illumination. Examples of motion sensor technologies that may be used include passive infrared (PIR), microwave, ultrasonic, tomographic, and video cameras. In exemplary embodiments, each motion sensor may comprise an unmodified, unrestricted passive infrared (PIR) sensor or a passive infrared detector (PID) rather than a restricted motion sensor. As used herein, the term “restricted motion sensor” is used to refer to a motion sensor in which the field-of-view has been partially occluded to cause the sensor to be more focused. System 100 may advantageously utilize unrestricted motion sensors that are typically already installed as a part of in-home monitoring platforms and can be deployed without the considerations necessary for more complex sensor systems—such as special placement to avoid camera occlusion or requiring a restricted 6 foot area such as with a sensor line. In this way, costs of deployment of system 100 may be reduced since system 100 may not require special sensors such as camera-based systems or restricted sensor arrays. In such an approach, the cost reduction from not having dedicated sensors for time out-of-home estimation can be considerable, especially when considering scaling a sensing platform for many homes.

In some examples, additional motion sensors, additional contact sensors, cameras, video cameras, and/or other sensor sources may be optionally included at one or more locations within home 104. For example, a second motion sensor source 118, e.g., a sensor line, may be included in home 104. The second motion sensor source 118 may be distinct from motion sensors 112, 114, and 116. The second motion sensor source 118 may be used in some examples to estimate additional activities of the subject, e.g., gait velocity. As another example, video cameras may be positioned adjacent to exterior doors of the home and may be used at least initially to establish a ground truth for the model used to estimate time out-of-home as described in more detail below.

In some examples, one or more other components, devices, or systems may be included in home 104 in order to facilitate time out-of-home estimation and/or to receive input from subject 102, and/or to provide information or present notifications to subject 102. For example, a computing device or interface 120 may be included in home 104. Device 120 may be configured to received input from subject 102, e.g., the subject may provide input indicating that a guest or other subject will be entering the space. As another example, the subject may provide input indicating a change that the system could use to increase accuracy of time out-of-home estimation. For example, the subject could provide information indicating that they will be staying at a different location for one or more days. In some examples, system 100 may use such subject input to calibrate the time out-of-home estimation model. As another example, device 120 or system 100 may be configured to output notifications and/or data. For example, in response to a change in time out-of home, device 120 may provide feedback to subject 102 to alert the subject to a subtle, undetected medical issue or encourage them to visit a doctor sooner for an issue that they may already know or suspect that they have. As another example, system 100 may send information calculated from the time out-of-home estimations to the subject, a caregiver, a family member, an external computing device, etc. Examples of information which may be provided include average time out-of-home, time out-of-home variability, average walking speed, maximum walking speed, variability in walking speed, an indication that the subject is at risk, an indication that the subject has a chronic condition, etc.

System 100 may additionally include a computing device 122. Computing device 122 may be in communication with each motion sensor in each room, each door sensor, and with other devices or components in the space. For example, computing device 122 may be directly coupled to the motion sensors and door sensors or may receive data from the sensors via a suitable network. Computing device 122 may be configured to receive sensor data, e.g., motion sensor and door sensor firing data, from each motion sensor in each room and each door sensor or contact sensor. Computing device 122 may include a logic subsystem and a data-holding subsystem which hold instructions executable by the logic subsystem to perform one or more of the various acts described herein.

System 100 may be used to implement methods for monitoring a time a subject, e.g., subject 102, spends outside of their home, e.g., home 104. In some embodiments, a computer-implemented method for determining time a subject spends outside of their home may comprise receiving sensor firing data for a duration from sensors in the home, where the sensors comprise an exterior door sensor and room motion sensors. The duration may comprise any suitable duration, e.g., a predetermined number of hours, a predetermined number of days, etc. In some examples, in order to remove “heartbeats,” consecutive door sensor firing data having the same signals may be removed prior to extracting features from the sensor firing data.

Embodiments of a method for determining time a subject spends outside of their home may further comprise dividing the duration into timer interval epochs, e.g., into five minutes time intervals or any other suitable time intervals. For each epoch, features may be extracted from the sensor firing data received during the epoch. Examples of features that may be extracted from the data are described in detail in the example given below. For example, extracting features from the sensor firing data received during the epoch may include calculating a number of sensor firings during the epoch. Extracting features may also include detecting whether the subject was in or out of a bed during the epoch based on sensor firing data from room motion sensors, e.g., from motion sensors in a bedroom. As another example, extracting features from the sensor firing data may further include, in response to the exterior door sensor being the last sensor fired during the epoch, indicating a leaving event during the epoch. As still another example, extracting features from the sensor firing data may further include, in response to the exterior door sensor being the first sensor fired during the epoch, indicating an arrival event during the epoch. As yet another example, extracting features from the sensor firing data may further include identifying whether or not the last motion sensor fired during the epoch occurred in a room of the home from which the subject could directly leave the home. Additionally, in some examples, extracting features from the sensor firing data received during the epoch may further comprise calculating forward and/or backward lags of one or more of the extracted features. For example, forward and/or backward lags of one or more of the number of sensor firings during the epoch, the last sensor fired during the epoch, and/or the first sensor fired during the epoch may be calculated.

Embodiments of a method for determining time a subject spends outside of their home may further comprise classifying, using a classifier, each epoch as an out-of-home epoch (meaning the subject is outside of the home during the epoch) or an in-home epoch (meaning the subject is inside the home during the epoch) based on the features extracted from the sensor firing data during the epoch. Classifying each epoch as out-of-home or in-home may comprise calculating a probability that the epoch is out-of-home or in-home. For example, an epoch may be classified as out-of-home if the calculated probability of the epoch is greater than 0.5 and the epoch may be classified as in-home if the calculated probability of the epoch is less than 0.5. The classifier may comprise any suitable classifier. As an example, the classifier may comprise a binary classifier that uses logistic regression to classify each epoch. The classifier may be trained in any suitable manner. In one example approach, the classifier may be trained on a training set to generate model parameters estimated by maximum likelihood.

In some embodiments, an amount of time, e.g., a total amount of time per day, the subject is out of the home may be calculated based on the classification of the epochs. Additionally, in some examples, a loneliness score may be generated based on the estimated amount of time the subject is out of the home. For example, a decreasing amount of time the subject is out of the home may be correlated with an increasing loneliness score. In some embodiments, a risk of loneliness may be indicated in response to the estimated amount of time out of the home less than a predetermined threshold.

Embodiments may additionally include generating time out-of-home profiles or probability distributions from which various patterns may be identified and assessed. For example, a variability in the amount of time the subject is out of the home may be calculated and a health state of the subject may be indicated based on the variability. As another example, if the duration of sensor firing data collection comprises a plurality of days, a distribution of probabilities that the subject is out of the home during different times of the day may be generated.

### EXAMPLE

The example discussed below demonstrates monitoring time a subject spends outside of the home in accordance with various embodiments. Embodiments may vary as to the methods of signal processing, methods of feature extraction, and models used, as well as the training of the models. The example discussed below is for illustrative purposes only and is not intended to be limiting.

### Methods

Data Collection. The data used in this example were collected from the homes of the Intelligent Systems for Assessing Aging Changes (ISAAC) cohort (Kaye J A et al J Gerontol Series B: Psych Sci Soc Sci 66B, i180-i190 (2011); incorporated by reference herein) and the ORCATECH Living Lab. These two cohorts comprised around 150 seniors living independently in the Portland community who had been monitored for the past 3-5 years. A core set of technologies was continually maintained in all homes, including pyroelectric motion sensors (MS16A, x10.com) in each room and contact sensors (DA10A, x10.com) on the refrigerator and doors to the home.

To collect ground truth data, motion activated video cameras (Logitech C600) were installed over the door in the homes of four different subjects. The video cameras were used capture when residents entered and exited the home while minimizing privacy issues by only recording video for 5 seconds when motion was detected. At installation, it was verified that the field of view of the camera was appropriately positioned to detect when people passed through the door. Each individual video file was first labeled with a home identifier and time stamp and then automatically uploaded to a data server. Using these data, outings from the home were hand-annotated. An outing was defined as any period where the resident left the home and closed the door behind them, leaving nobody else in the house. Thirty days of valid video data were collected from each home.

While the cameras collected data, data from motion sensors in each room of the home as well as contact sensors on the doors of the home were simultaneously collected. The infrared motion sensors functioned by firing a signal each time movement is detected, with a refractory period after firing of about 6 seconds. The contact sensors were magnetic, and fired a different signal when the two magnets were together (when the door was closed) than when they were apart (when the door was open). These contact data had heartbeats: if no event occurs within about an hour, the contact sensor emitted a signal corresponding to whatever state it was in at present. To remove heartbeats, consecutive data points with the same signal were removed from the data stream.

Feature Selection. To derive the features used in the model development, the sensor data from each home was first divided into 5 minute epochs. Because most out-of-home events last at least 30 minutes, this window size was small enough to capture the outing events with high sensitivity, while remaining large enough facilitate data processing and analysis. For each epoch, thirteen features were calculated—five initial features and the forward and backward lags from four of them—and used in the model development.

The first feature included in the model corresponds to the number of sensor firings during each five minute interval. Because the motion sensors in the home are event driven, the number of sensor firings should be very low or zero when nobody is present in the home. On the other hand, the number of sensor firings should increase when someone is present in the home provided they are moving about. To account for periods where the subject is both home and not moving (e.g. during naps or overnight), the second extracted feature corresponds to whether the subject was in or out of bed, as calculated using the heuristic approach developed by Hayes T L et al presented at Engineering in Medicine and Biology Society, 2010 Annual International Conference of the IEEE (2010); incorporated by reference herein.

The next two extracted features corresponded to the firing of door sensor events and were designed to capture entry and exit events from the home. Two key observations were made regarding the door sensor and outings from the home. First, when the subject leaves the home, the last sensor firing in the home during the departure epoch should be a door sensor. Second, when the subject arrives back home, the first sensor firing in the home during the arrival epoch should be a door sensor. In between these two events, few, if any, sensor firings should occur. However, simply looking for these events to happen consecutively is not enough as door sensor firings are noisy and can be missed. For example, if a door opening event is not recorded, the corresponding door closing event will be treated as a heartbeat and removed from the sensor stream. To create the most robust model, two separate door sensor features were incorporated into the model. The first, corresponding to a leaving event, operates on the intuition that periods of inactivity following a door sensor likely correspond to out-of-home events. For this feature, periods where the door sensor was the last sensor that fired during the epoch were identified. All epochs between this event and the next movement event, where movement is defined as at least 3 consecutive sensor firings, were labeled as ‘1’, corresponding to epochs where the person was likely out of the home. The second door sensor feature corresponds to an arrival event, and operates on the intuition that periods of inactivity preceding a door sensor firing likely also correspond to out-of-home events. For this feature, all epochs where the door sensor was the first sensor in the epoch were identified and all epochs between this event and the previous movement event were labeled as ‘1’.

Another extracted feature included in the model simply indicates whether the last recorded sensor firing occurred in a room from which the subject could leave the house. This feature was calculated independent of the true home layout. Rather, rooms that were deemed unlikely to leave the home from without first tripping a different sensor (e.g. a bedroom) were labeled ‘0’ while those a resident may be able to directly leave the home from (e.g. the living room) were labeled ‘1’. Each epoch was then labeled according to the value of the last sensor firing. This feature was important to distinguish events where the resident arrived home and opened the door from those where the resident was in the home but not moving when someone else arrived and opened the door. Although using the home-specific layouts could provide better labeling for training purposes, this approach would not readily generalize to new homes. Additionally, in order to capture some of the time-series nature of outings from the home, forward and backward lags of one epoch for each of the above-described features except the bed feature were also used in the classifier.

Model Development. Detecting outings based on the extracted features was treated as a binary classification on each epoch. Embodiments may use any suitable method to classify binary data exist, e.g., support vector machines, neural networks, logistic regression, etc. In this example, logistic regression was used to classify the data [26] because of the ease of interpretability of the results. Logistic regression is based on the assumption that the “log-odds” of the outcome is linear in the parameters. From this assumption, the conditional probability follows a logistic distribution given by the following Equation 1:

P(yᵢ=1|xᵢ)=exp(xᵢβ)/1+exp(xᵢβ) (1)

In Equation 1, yᵢ is a binary indicator variable corresponding to ‘1’ if nobody is in the home during epoch i (the participant is out-of-home) and ‘0’ otherwise, xᵢ is the feature vector for epoch i, and, β represents the vector of model parameters which can be estimated using maximum likelihood.

To optimize model performance and applicability, the model was trained on the same number of out-of-home events as in-home events. This resulted in training on ¼ of the in-home epochs (7745 of 30,980 epochs), and ¾ of the out-of-home epochs (7678 of 10,198 epochs). The trained model was tested on all the remaining data. For all model fits, 1000 fold repeated random sub-sampling was used to determine mean out-of-sample performance, parameter estimates, and 95% confidence intervals (CI) for sensitivity and specificity with a decision threshold of 0.5 (that is, samples with a probability greater than 0.5 were classified as ‘out-of-home’, and those with a probability less than 0.5 were classified as ‘in-home’).

Initially, the logistic regression model was trained using all the data and all the features described above. Parameter estimates and 95% confidence intervals for each feature were calculated using these data. All features with parameter estimates whose 95% confidence intervals included zero were removed from the model, and the model was refit using the reduced feature set. This process was continued until all included features proved significant. Through this process, four features were removed: the forward and backward lags of the number of sensor firings, the backward lag of the first door sensor, and the forward lag of the last door sensor. All other features were significant. The results of the model with the final feature set are described below.

### Results

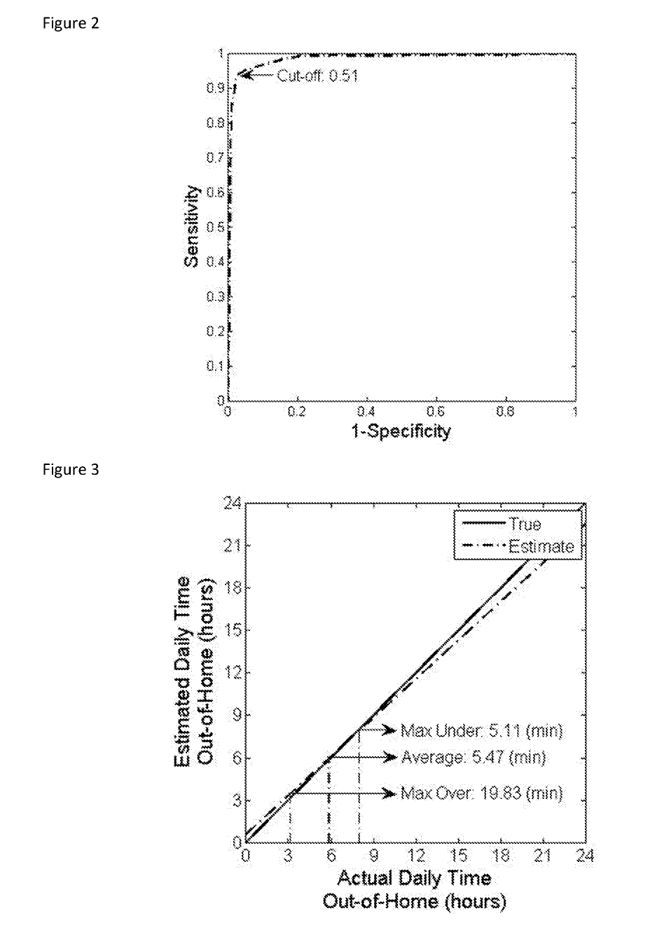

The logistic regression based classifier performed well with a sensitivity of 0.939 (95% CI: 0.931, 0.947) and specificity of 0.975 (95% CI: 0.973, 0.977). This high performance can also be visualized in the ROC curve shown in FIG. 2. The ideal threshold for classifying this data is likely 0.51. After this point, a small increase in sensitivity causes large drops in specificity, quickly resulting in dramatic overestimation of time out-of-home.

While reporting sensitivity and specificity is important, the true goal of this model is to estimate how much time an individual spends out of the home. For that reason, calculating the difference between the estimated time out-of-home and the true time out-of-home is important. This difference will vary as a function of the proportion of time spent out-of-home. That is, for individuals who go out frequently, the low sensitivity may cause underestimation of time out-of-home, while the time out-of-home may be over-estimated for those who seldom leave. To compute the expected bias in minutes, the probability of false positive (1−sₚ) and the probability of false negative (1−sₑ)(p) were estimated and their difference multiplied by the number of minutes in a day was calculated according to the following Equation 2:

b̅=1440 [(1−sₚ)(1−p)−(1−sₑ)(p)] (2)

In Equation 2, sₚ is the specificity of the model, sₑ is the sensitivity of the model, and p is the proportion of time spent out-of-home. Using this estimate of the bias, FIG. 3 shows the relationship between true daily time out-of-home and the estimate of time out-of home for a sensitivity of 0.939 and specificity of 0.975. In the population of four subjects used in this example, the lowest average daily time out-of-home was 3 hours per day. For this subject, the classifier will overestimate their time out-of-home by 19.8 minutes per day on average. On the other hand, the highest average time out-of-home was 8 hours per day, and the classifier will underestimate this subject's time out-of-home by 5.1 minutes per day on average. Across subjects, the classifier will overestimate time out-of-home by 5.5 minutes per day on average. Within the range of probable average daily time out-of-home, this classifier performs very well at estimating the true time out-of-home.

This performance gives some indication of the noisiness of the sensor data. For example, many of the false negatives (periods classified as ‘in’ when nobody was actually in the home) occurred when sensors would fire in the home while the resident was out, likely due to sources of heat inside the apartment (e.g. space heaters, pets, or sun through the window). Indeed, in two separate homes, it was discovered that sensors often fired while the resident was out of the home—one likely due to a computer turning on and causing a change in heat patterns in the room, and the other likely due to sun through the window. Because it is nearly impossible to detect and eliminate all mis-firings, none of these events was removed from the sensor data stream. Instead, the model performance gives an indication of how the model would perform under true conditions, which are typically noisy.

In general, these noise issues as well as noise associated with the door sensors themselves were handled by accounting for both arrival and departure events. If the arrival door event was excluded from the model, the sensitivity dropped only slightly to 93.1% while the specificity dropped considerably to 82.6%. Exclusion of the departure door event dropped the sensitivity to 90.67% while the specificity remained largely unaffected at 96.6%. This difference between the arrival and departure door sensor events indicates more errors occur with door sensors when subjects are leaving the home than when they arrive back home.

### Example Applications

The example described above demonstrated that the approaches described herein can detect outings from the home with high accuracy. In the following, example non-limiting applications of this model are described.

Loneliness and Outings. In June of 2012, subjects from both the ISAAC cohort and the ORCATECH living lab were administered an online version of the UCLA loneliness scale (Russell D W et al, J Pers Soc Psychol 39, 472-480 (1980); incorporated by reference herein), a well validated survey for assessing loneliness. This survey asks questions such as “I do not feel alone” and “There are people I feel close to”, where response options are: (1) Never, (2) Rarely, (3) Sometimes and (4) Often. Because this survey was administered online rather than in-person, a response for ‘do not wish to answer’ was also added. After reversing the value of negative questions, the value of each answer was summed across the twenty questions to give a loneliness score ranging from 20 to 80, with 80 being the loneliest. The least lonely individual scored 21 on this survey, while the loneliest individual from the cohort scored 60. The mean value was 35 with a standard deviation of 7.87, which is consistent with values obtained by Russell et al in validating the UCLA Loneliness Scale for the elderly (Russell J Pers Assess 66, 20-40 (1996); incorporated by reference herein).

Loneliness score was correlated with the average time spent outside the home over the five days up to and including survey administration. This interval was chosen to provide the most robust summary of average outings while eliminating as much recall bias as possible. This analysis included only those subjects with valid sensor data who answered all questions on the questionnaire (34 people) and who live alone. Of those 34 individuals, two were traveling away from home for at least three of the five days prior to filling out the survey and were therefore excluded from this aspect of the study. This left a total of 32 subjects who completed the loneliness survey and had valid sensor data. These subjects' data were used to explore the correlation between outings and loneliness.

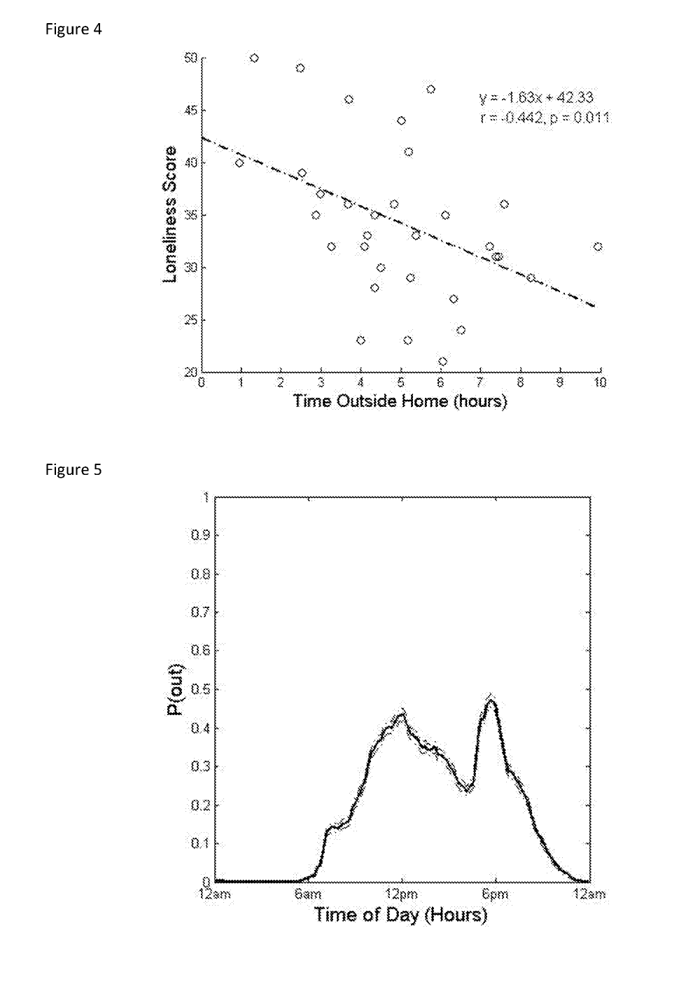

FIG. 4 shows the correlation between the average time spent outside the home over the course of the four days up to and including survey administration and the corresponding loneliness score. As can be seen, average time outside the home was found to be negatively correlated with the loneliness score, indicating those who spend more time at home tend to be lonelier. This is consistent with research showing a negative correlation between loneliness and physical exercise, social activity, and mobility. Still, the correlation is significant (p=0.011) but modest (r=−0.44). Obviously, it is possible for some individuals to stay at home but not experience loneliness. Including other factors that influence loneliness such as social contact with others, sleep disturbances, and daytime dysfunction would assist in creating a more complete model of loneliness in the home.

Outings by Time of Day. While the total time spent outside the home is important, various factors can influence the time spent outside the home. For example, in retirement communities people typically take meals in the central dining hall. Leaving simply to eat a meal may not influence loneliness the same way that leaving to play games with close friends would. For this reason, it is also important to view outings as a function of the time of day.

For this aspect of the study, the outing model was used to compute outings, y for every five minute interval over the thirty days prior to completing the loneliness survey where y=1 if the individual was out of the home, and y=0 if the individual was in the home. By averaging the corresponding y values for each subject and day, a picture of the probability of leaving the home as a function of the time of day was generated. FIG. 5 shows the probability of leaving over the entire population of 51 individuals living alone in the community who completed the survey and had any full days of sensor data during the 30 day period prior to survey completion. Clear peaks can be discerned at around noon and 6 p.m., corresponding to the lunch and dinner hours, respectively. The probability of being out of the home at these times was 0.5, indicating that at noon and 6 p.m., an average of 50% of our elderly population is outside the home on any given day. Further, these subjects are more likely to be out of the home in the early afternoon, perhaps when most errands are completed. Not surprisingly, FIG. 5 also shows that the cohort is almost certainly at home during the night, consistent with sleep patterns.

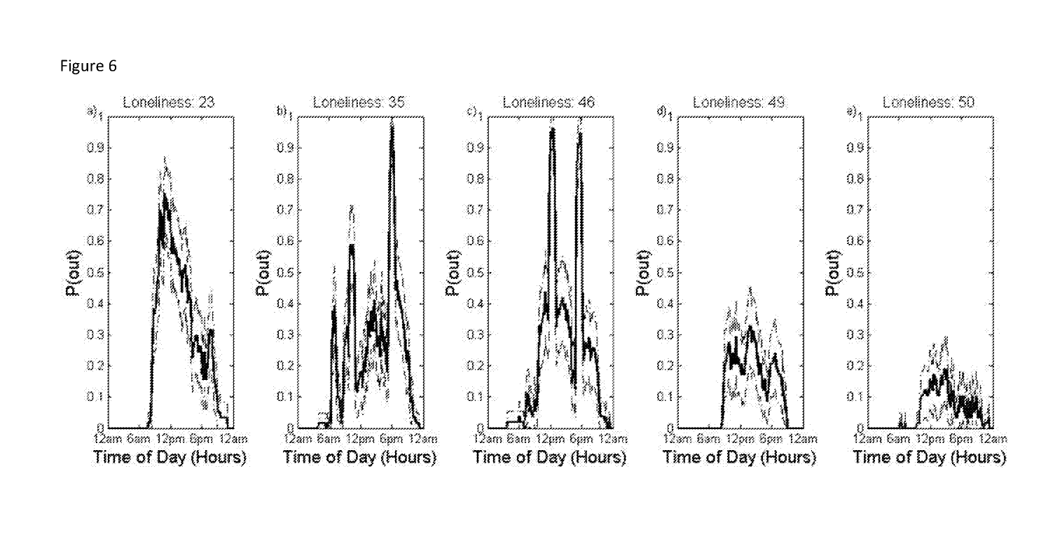

While trends across the population are important for summarizing how elderly spend their time, individual trends are also important. To illustrate the variability of outing patterns of lonely and non-lonely individuals, the probability of being out was plotted for a representative sample of five subjects with varying loneliness scores. Their loneliness scores and corresponding probability of being out of the home are shown in FIG. 6(a-e). Clear meal times and an obvious regularity can be discerned in FIG. 6, Panels A-D, but this regularity is largely absent in FIG. 6, Panel E—the loneliest individual plotted.

It was worth noting that the individuals in FIG. 6 Panel A, C, and D lived in retirement communities where they could take meals in the local dining hall. While the individual plotted in FIG. 6 Panel A left the home regularly in the late afternoon, the main peaks in FIG. 6 Panel C surround the lunch and dinner mealtimes. This mealtime regularity is also seen in FIG. 6 Panel D, although this individual rarely left the home at all. This may suggest that outings other than simple mealtime outings are important in assessing loneliness for individuals living in a retirement community. On the other hand, mealtime outings for individuals living alone in the community may represent an important aspect of socialization, and contribute greatly to decreasing loneliness. This is seen in FIG. 6, Panel B. This individual lived alone in the community and, even though his most common outing times surround the mealtimes, he was not lonely. Likely he was getting a great deal of socialization when he left his home to get a meal with a friend, which helps ward off loneliness. Taking into account these different lifestyles may be important in unobtrusively modeling loneliness in the home.

Outings and Physical Activity. Many physical activities are done outside the home, so an exploration of how outings from the home correlate with self-report of physical exercise was undertaken. Concurrent with the administration of the UCLA loneliness scale, subjects also completed a physical activity survey from Berkman's Social Disengagement Index (Bassuk S et al, Ann Intern Med 131, 165-173 (1999); incorporated by reference herein). This fifteen item survey queries subjects regarding activities they do both in and outside the home. To get a composite score of outside activities, scores on three questions were reversed: (i) How often do you prepare your own meals, (ii) How often do you read books, magazines, or newspapers, and (iii) How often do you watch television, as these are activities likely done inside the home. After reversing these scores, the scores on all questions were summed to give a total outdoor activity index.

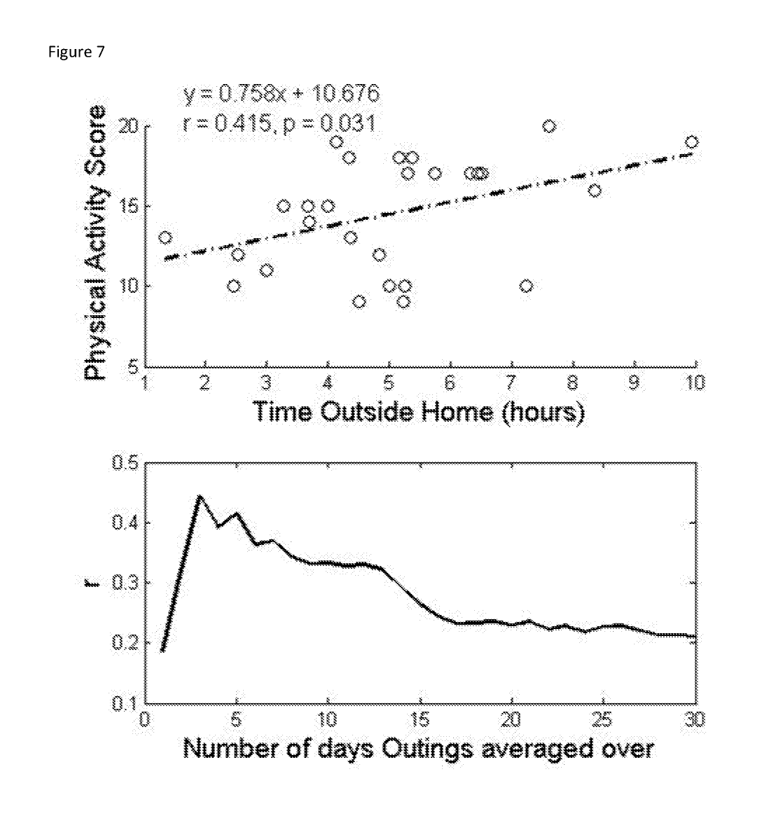

A plot of the correlation between the physical activity score and the average time spent outside the home over the four days up to and preceding survey administration is shown in FIG. 7 Panel A. As can be seen, physical activity score is positively correlated with average time spent outside the home (r=0.415, p=0.031), indicating outings are also an important measure of physical activity. This correlation is also prone to recall bias. FIG. 7 Panel B shows a plot of the correlation as a function of the window of observation. While looking at only the same day as the survey generates the worst correlation, the best correlation is seen when averaging around 3-7 days of outing activity. The correlation then drops considerably until it plateaus at around 18 days of outing data. This result is consistent with the salience effects seen by Eagle et al. in their correlation of self-report of proximity patterns of other individuals with Bluetooth phone logs (Eagle N et al, Proc Natl Acad Sci USA 106, 15274-15278 (2009); incorporated by reference herein), suggesting human recall favors the recent events.

The examples described above demonstrated and validated a logistic regression based classifier to detect outings from the home on longitudinal data from subjects currently monitored in their own homes. The classifier performed very well with a sensitivity of 0.939 and specificity of 0.975, but it depended heavily on door sensors firing. Thus, based on these results, it may be advantageous to perform simple tests for door sensor functionality prior to using the model.

Embodiments described herein have several practical applications. For example, it was demonstrated that time outside the house is negatively correlated with loneliness, indicating the utility of time out-of-home in any unobtrusive model of loneliness. A general pattern of out-of-home behavior was also demonstrated in an elderly population consistent with prior research. The results showed that outing patterns vary substantially on an individual level which may be useful in detecting individuals at increased risk of loneliness, for example. Additionally, time out-of-home was correlated with physical activity, and it was demonstrated that an individual's self-report of physical activity may be subject to recall bias. In summary, the approaches described herein may be used to accurately detect out-of-home events to thereby improve point-of-care in the home setting, particularly for loneliness and other adverse health outcomes whose symptoms present with an increased, decreased, or more variable pattern of out-of-home behaviors.

In some embodiments, the above described methods and processes may be tied to a computing system, including one or more computers. In particular, the methods and processes described herein may be implemented as a computer application, computer service, computer API, computer library, and/or other computer program product.

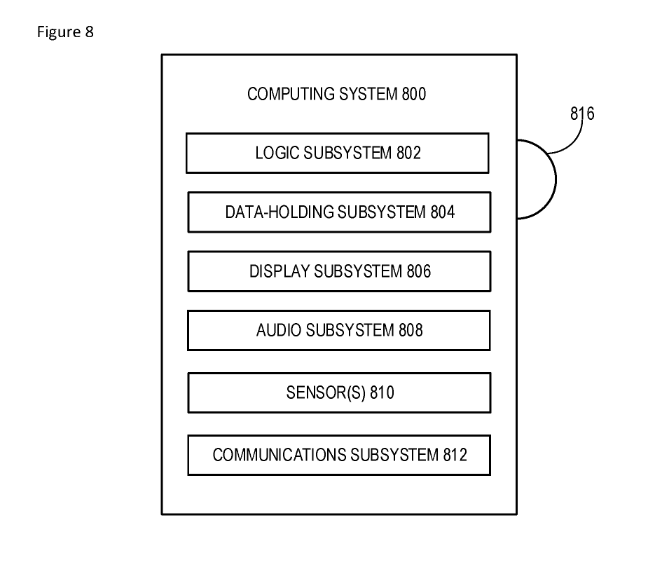

FIG. 8 schematically shows a non-limiting computing device 800 that may perform one or more of the above described methods and processes. For example, FIG. 8 may represent one or more computing devices or processors included in system 100 shown in FIG. 1 described above, e.g., computing device 122. Computing device 800 is shown in simplified form. It is to be understood that virtually any computer architecture may be used without departing from the scope of this disclosure. In different embodiments, computing device 800 may take the form of a microcomputer, an integrated computer circuit, microchip, a mainframe computer, server computer, desktop computer, laptop computer, tablet computer, home entertainment computer, network computing device, mobile computing device, mobile communication device, gaming device, etc.

Computing device 800 includes a logic subsystem 802 and a data-holding subsystem 804. Computing device 800 may also include a display subsystem 806, an audio subsystem 808, one or more sensors 810, a communication subsystem 812, and/or other components not shown in FIG. 8. Computing device 800 may also optionally include user input devices such as manually actuated buttons, switches, keyboards, mice, game controllers, cameras, microphones, and/or touch screens, for example.

Logic subsystem 802 may include one or more physical devices configured to execute one or more machine-readable instructions. For example, the logic subsystem may be configured to execute one or more instructions that are part of one or more applications, services, programs, routines, libraries, objects, components, data structures, or other logical constructs. Such instructions may be implemented to perform a task, implement a data type, transform the state of one or more devices, or otherwise arrive at a desired result.

The logic subsystem may include one or more processors that are configured to execute software instructions. For example, the one or more processors may comprise physical circuitry programmed to perform various acts described herein. Additionally or alternatively, the logic subsystem may include one or more hardware or firmware logic machines configured to execute hardware or firmware instructions. Processors of the logic subsystem may be single core or multicore, and the programs executed thereon may be configured for parallel or distributed processing. The logic subsystem may optionally include individual components that are distributed throughout two or more devices, which may be remotely located and/or configured for coordinated processing. One or more aspects of the logic subsystem may be virtualized and executed by remotely accessible networked computing devices configured in a cloud computing configuration.

Data-holding subsystem 804 may include one or more physical, non-transitory, devices configured to hold data and/or instructions executable by the logic subsystem to implement the herein described methods and processes. When such methods and processes are implemented, the state of data-holding subsystem 804 may be transformed (e.g., to hold different data).

Data-holding subsystem 804 may include removable media and/or built-in devices. Data-holding subsystem 804 may include optical memory devices (e.g., CD, DVD, HD-DVD, Blu-Ray Disc, etc.), semiconductor memory devices (e.g., RAM, EPROM, EEPROM, etc.) and/or magnetic memory devices (e.g., hard disk drive, floppy disk drive, tape drive, MRAM, etc.), among others. Data-holding subsystem 804 may include devices with one or more of the following characteristics: volatile, nonvolatile, dynamic, static, read/write, read-only, random access, sequential access, location addressable, file addressable, and content addressable. In some embodiments, logic subsystem 802 and data-holding subsystem 804 may be integrated into one or more common devices, such as an application specific integrated circuit or a system on a chip.

FIG. 8 also shows an aspect of the data-holding subsystem in the form of removable computer-readable storage media 816, which may be used to store and/or transfer data and/or instructions executable to implement the herein described methods and processes. Removable computer-readable storage media 816 may take the form of CDs, DVDs, HD-DVDs, Blu-Ray Discs, EEPROMs, flash memory cards, and/or floppy disks, among others.

When included, display subsystem 806 may be used to present a visual representation of data held by data-holding subsystem 804. As the herein described methods and processes change the data held by the data-holding subsystem, and thus transform the state of the data-holding subsystem, the state of display subsystem 806 may likewise be transformed to visually represent changes in the underlying data. Display subsystem 806 may include one or more display devices or surfaces utilizing virtually any type of technology. Such display devices or surfaces may be combined with logic subsystem 802 and/or data-holding subsystem 804 in a shared enclosure, or such display devices or surfaces may be peripheral display devices or surfaces.

When included, audio subsystem 808 may be used to present an audio representation of data held by data-holding subsystem 804. As the herein described methods and processes change the data held by the data-holding subsystem, and thus transform the state of the data-holding subsystem, the state of audio subsystem 808 may likewise be transformed to represent changes in the underlying data via sounds or vibrations. Audio subsystem 808 may include one or more devices or components capable of vibration, e.g., speakers or the like. Such devices may be combined with logic subsystem 802 and/or data-holding subsystem 804 in a shared enclosure, or such devices may be peripheral devices. In some embodiments, computing device 800 may additionally include a haptic subsystem including one or vibration components which may be used to present haptic representations of data held by data-holding subsystem 804.

Computing system 800 may further include one or more sensors 810, e.g., one or more motions sensors and/or one or more contact sensors. For example, motion sensors included in system 800 may utilize virtually any suitable motion sensing technology. Examples of motion sensors which may be included in computing system 800 include unrestricted motion sensors, passive infrared (IR) motion sensors, microwave motion sensors, ultrasonic motions sensors, tomographic motions sensors, video camera based motion sensors, sensor lines, image capture devices, and various other sensors (examples of which are described above with regard to FIG. 1). Any contact sensors included in system 800 may utilize virtually any suitable contact sensing technology. Examples of contact sensors which may be included in computing system 800 include magnetic contact sensor or switches, among others. Contact switches included in system 800 may comprise first and second components and may be configured to emit a first signal when the first and second components are in physical contact with each other and a second signal, different from the first signal, when the first and second components are not in physical contact with each other.

When included, communication subsystem 812 may be configured to communicatively couple computing device 800 with one or more other computing devices and/or with various external sensors, components, or systems. Communication subsystem 812 may include wired and/or wireless communication devices compatible with one or more different communication protocols. As non-limiting examples, the communication subsystem may be configured for communication via a wireless telephone network, a wireless local area network, a wired local area network, a wireless wide area network, a wired wide area network, etc. In some embodiments, the communication subsystem may allow computing system 800 to send and/or receive messages to and/or from other devices via a network such as the Internet.

Computing system 800 may further include various subsystems configured to execute one or more instructions that are part of one or more programs, routines, objects, components, data structures, or other logical constructs. Such subsystems may be operatively connected to logic subsystem 802 and/or data-holding subsystem 804. In some examples, such subsystems may be implemented as software stored on a removable or non-removable computer-readable storage medium.

It is to be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated may be performed in the sequence illustrated, in other sequences, in parallel, or in some cases omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

1. A computer-implemented method for determining time a subject spends outside of their home, comprising:
receiving sensor firing data for a duration from sensors in the home, the sensors comprising an exterior door sensor and room motion sensors;
dividing the duration into epochs;
for each epoch, extracting features from the sensor firing data received during the epoch, wherein extracting features from the sensor firing data received during the epoch comprises:
calculating a number of sensor firings during the epoch;
detecting whether the subject was in or out of a bed during the epoch based on sensor firing data from room motion sensors;
in response to the exterior door sensor being the last sensor fired during the epoch, indicating a leaving event during the epoch;
in response to the exterior door sensor being the first sensor fired during the epoch, indicating an arrival event during the epoch;
identifying whether or not the last motion sensor fired during the epoch occurred in a room of the home from which the subject could directly leave the home; and
classifying, using a classifier, each epoch as out-of-home or in-home based on the features extracted from the sensor firing data during the epoch.

2. The method of claim 1, wherein extracting features from the sensor firing data received during the epoch further comprises calculating forward and/or backward lags of one or more of the extracted features.

3. The method of claim 1, wherein extracting features from the sensor firing data received during the epoch further comprises calculating forward and/or backward lags of one or more of
the number of sensor firings during the epoch, the last sensor fired during the epoch, and the first sensor fired during the epoch.

4. The method of claim 1, wherein the classifier comprises a binary classifier.

5. The method 4, wherein the classifier uses logistic regression to classify each epoch.

6. The method of claim 1, wherein classifying each epoch as out-of-home or in-home comprises calculating a probability that the epoch is out-of-home or in-home.

7. The method of claim 6, wherein an epoch is classified as out-of-home if the calculated probability of the epoch is greater than 0.5 and the epoch is classified as in-home if the calculated probability of the epoch is less than 0.5.

8. The method of claim 1, wherein the classifier is trained on a training set to generate model parameters estimated by maximum likelihood.

9. The method of claim 1, further comprising estimating an amount of time the subject is out of the home based on the classification of the epochs.

10. The method of claim 9, further comprising generating a loneliness score based on the estimated amount of time the subject is out of the home, wherein a decreasing amount of time the subject is out of the home is correlated with an increasing loneliness score.

11. The method of claim 9, further comprising indicating a risk of loneliness in response to the estimated amount of time out of the home less than a threshold.

12. The method of claim 1, wherein the duration comprises a plurality of days and wherein the method further comprises generating a distribution of probabilities that the subject is out of the home during different times of the day.

13. The method of claim 1, further comprising removing consecutive door sensor firing data having the same signals prior to extracting features from the sensor firing data.

14. The method of claim 1, wherein the exterior door sensor comprises a contact sensor.

15. The method of claim 14, wherein the contact sensor comprises a magnetic contact sensor.

16. The method of claim 1, wherein the room motion sensors comprise infrared motion sensors.

17. The method of claim 1, further comprising calculating a variability in the amount of time the subject is out of the home and indicating a health state of the subject based on the variability.

18. A system for monitoring time a subject spends outside of their home, comprising:
one or more room motion sensors positioned in rooms of the home;
an exterior door sensor coupled to an exterior door of the home; and
a computing device in communication with each sensor, the computing device comprising:
a logic subsystem; and
a data-holding subsystem holding instructions executable by the logic subsystem to perform the steps of claim 1.

19. The system of claim 18, wherein the exterior door sensor comprises a contact sensor.

20. The system of claim 19, wherein the contact sensor comprises a magnetic contact sensor.

21. The system of claim 18, wherein the room motion sensors comprise infrared motion sensors.

22. The system of claim 18, wherein the one or more motion sensors comprise a motion sensor in each room of the home.
